(19) United States
(12) Patent Application Publication
(10) Pub. No.: US 2018/0358669 A1
(43) Pub. Date: Dec. 13, 2018

(54) BATTERY ASSEMBLY

(71) Applicant: GM GLOBAL TECHNOLOGY OPERATIONS LLC, Detroit, MI (US)

(72) Inventors: Roger M. Brisbane, Washington, MI (US); Todd H. Fast, Huntington Woods, MI (US)

(73) Assignee: GM GLOBAL TECHNOLOGY OPERATIONS LLC, Detroit, MI (US)

(21) Appl. No.: 15/616,517

(22) Filed: Jun. 7, 2017

(51) Int. Cl. H01M 10/6555; H01M 10/0525; H01M 10/617; H01M 10/653; H01M 10/625

(52) U.S. Cl. CPC H01M 10/6555; H01M 10/0525; H01M 2220/20; H01M 10/653; H01M 10/625; H01M 10/617

(57) ABSTRACT

A rechargeable battery assembly includes battery cells, a plurality of heat spreaders, a first heat exchanger and a second heat exchanger. Each heat spreader includes a plate portion, a first end portion and a second end portion. The battery cells are disposed in a stacked arrangement, with the heat spreaders interleaved between adjacent ones of the battery cells. Fluidic channels includes a first port that is in fluidic communication with the first manifold and a second port that is in fluidic communication with the second manifold. The fluidic channels are disposed between the first and second fluidic manifolds. The stacked arrangement is interposed between the first heat exchanger and the second heat exchanger. The first end portions of the heat spreaders are in thermal contact with the first heat exchanger and the second end portions of the heat spreaders are in thermal contact with the second heat exchanger.

### INTRODUCTION

Battery cells, e.g., lithium-ion battery cells operate most effectively over a defined temperature range, and can generate heat during recharging events

### SUMMARY

A rechargeable battery assembly is described and includes a plurality of battery cells, a plurality of heat spreaders, a first heat exchanger and a second heat exchanger. Each heat spreader includes a plate portion, a first end portion and a second end portion. The plurality of battery cells are disposed in a stacked arrangement, with the heat spreaders interleaved between adjacent ones of the battery cells. Each of the first and second heat exchangers includes a first planar sheet assembled onto a second planar sheet, and a plurality of fluidic channels are disposed between the first and second planar sheets. A first fluidic manifold is disposed on a first edge and a second fluidic manifold is disposed on a second opposed edge of each of the first and second heat exchangers. Each of the fluidic channels includes a first port that is in fluidic communication with the first manifold and a second port that is in fluidic communication with the second manifold. Each of the fluidic channels is disposed to provide fluidic communication between the first and second fluidic manifolds. The stacked arrangement of the plurality of battery cells and interleaved heat spreaders is interposed between the first heat exchanger and the second heat exchanger. Each of the first end portions of the heat spreaders is in thermal contact with the first heat exchanger and each of the second end portions of the heat spreaders is in thermal contact with the second heat exchanger.

An aspect of the disclosure includes each of the battery cells being configured as a rectangular prism and including a first edge, a second edge, opposed face portions and electrical terminal ends.

Another aspect of the disclosure includes the heat spreaders being interleaved between adjacent ones of the battery cells such that the plate portion of each of the heat spreaders is in thermal communication with the adjacent ones of the battery cells.

Another aspect of the disclosure includes the thermal communication including conductive heat transfer, radiant heat transfer and convective heat transfer.

Another aspect of the disclosure includes the heat spreaders being fabricated from one of aluminum, stainless steel, high-strength steel, other metals or carbon sheets.

Another aspect of the disclosure includes the first portions of the heat spreaders being bonded to the first heat exchanger via a thermally-conductive adhesive material, wherein the second portions of the heat spreaders are bonded to the second heat exchanger via the thermally-conductive adhesive material.

Another aspect of the disclosure includes the first end portion of the heat spreader being in thermal communication with the first heat exchanger and the second end portion is in thermal communication with the second heat exchanger, and wherein each of the heat spreaders is in thermal contact with the respective inner portion of the first planar sheet and the respective inner portion of the second planar sheet via the thermally-conductive adhesive material.

Another aspect of the disclosure includes the first and second planar sheets of the first and second heat exchangers being fabricated from one of aluminum, stainless steel, high-strength steel or other thermally-conductive material.

Another aspect of the disclosure includes each of the battery cells being a rechargeable lithium-ion battery cell.

Another aspect of the disclosure includes the first manifold being arranged in parallel with the second fluidic manifold for each of the first and second heat exchange plates.

Another aspect of the disclosure includes the first fluidic manifold, the plurality of fluidic channels and the second fluidic manifold forming a single-pass fluidic flow circuit in each of the first and second heat exchange plates.

Another aspect of the disclosure includes each of the first and second heat exchangers being arranged in a single-pass fluidic flow circuit that includes the first fluidic manifold, the plurality of fluidic channels and the second fluidic manifold.

Another aspect of the disclosure includes each of the fluidic channels having a rectangular, trapezoidal, semi-circular or elliptical cross-sectional shape.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates an exploded isometric view of a battery assembly that includes a plurality of battery cells, a plurality of interleaved heat spreaders, a first heat exchanger that is disposed in an upper position, and a second heat exchanger that is disposed in a lower position, in accordance with the disclosure; and

FIG. 2 schematically illustrates an isometric view of a portion of the battery assembly described with reference to FIG. 1, in accordance with the disclosure.

The appended drawings are not necessarily to scale, thus presenting a somewhat simplified representation of various preferred features of the present disclosure as disclosed herein, including, for example, specific dimensions, orientations, locations, and shapes. Such details are to be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, upper, lower, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

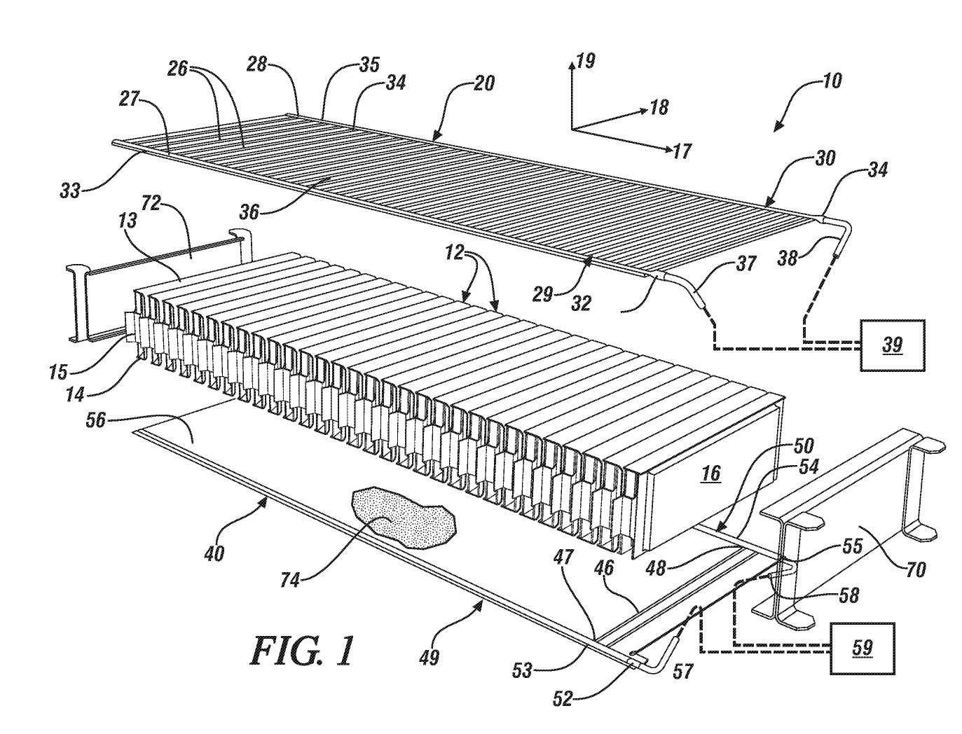

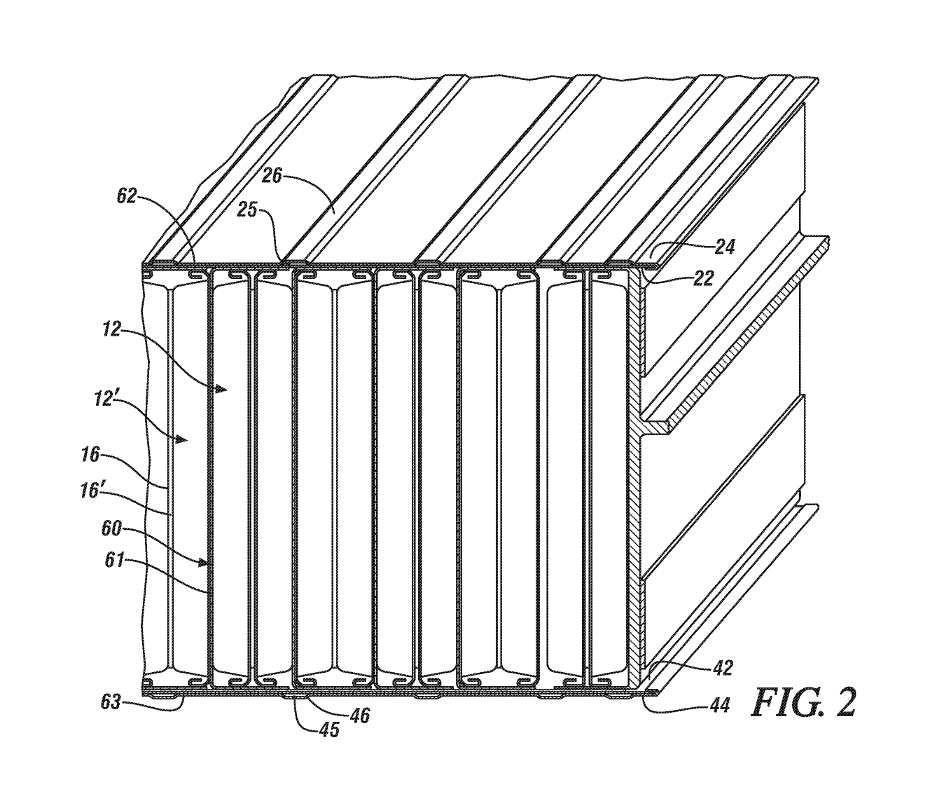

Referring to the drawings, wherein like reference numerals correspond to like or similar components throughout the several Figures, FIGS. 1 and 2 schematically illustrate an embodiment of a battery assembly 10 that includes a plurality of battery cells 12, a plurality of heat spreaders 60, a first heat exchanger 20 that is disposed in an upper location as shown, and a second heat exchanger 40 that is disposed in a lower location as shown. The battery assembly 10 may include other elements, e.g., temperature sensors, current sensors, electrical conductors and structural members that are not illustrated herein. A three-dimensional coordinate system is indicated for purposes of describing relational positions of the various elements, and includes a longitudinal axis 17, a transverse axis 18 and an elevation axis 19. The battery assembly 10 described herein may serve as a high-voltage DC electric power source that can be disposed in a passenger compartment of a vehicle. The vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the battery assembly 10 may be disposed in another application.

Each of the battery cells 12 is preferably configured as a rectangular prism having a first, top edge 13, and second, bottom edge 14, a terminal edge 15, and opposed planar faces 16. Each of the battery cells 12 may be an electrochemical unit that includes lithium-ion electrodes and an electrolyte that are enclosed in a sealed container.

Each of the heat spreaders 60 is preferably configured as a rectangular sheet that is formed to include a planar plate portion 61 with a first end portion 62 that is orthogonal to the planar surface of the plate portion 61 and a second end portion 63 that is orthogonal to the planar surface of the plate portion 61. The first end portion 62 preferably projects orthogonal to the planar surface of the plate portion 61 in a first direction and the second end portion 63 preferably projects orthogonal to the planar surface of the plate portion 61 in a second direction that is preferably opposite to the first end portion 62. The planar surfaces of the plate portions 61 and the opposed planar faces 16 of the battery cells 12 are preferably coplanar with a plane defined by the transverse axis 18 and the elevation axis 19. The planar surfaces of the first and second end portions 62, 63 are preferably coplanar with a plane defined by the longitudinal axis 17 and the transverse axis 18. Each of the heat spreaders 60 is fabricated from aluminum or another metal or other material that is suitable for heat transfer, such as carbon sheets.

The battery cells 12 are preferably arranged in a stacked configuration in relation to the longitudinal axis 17, such that adjacent ones of the battery cells 12, 12′ have respective planar faces 16, 16′ that are arranged in opposition to one another, with the plate portion 61 of one of the heat spreaders 60 being interleaved therebetween. First and second end plates 70, 72, respectively, are attached to complete the enclosure of the stacked configuration of the battery cells 12.

Heat transfer between each planar face 16 of each of the battery cells 12 and the plate portion 61 of a contiguous one of the heat spreaders 60 can be in the form of conductive heat transfer via direct physical contact, convective heat transfer or radiant heat transfer. Heat transfer can be employed to effect cooling of the battery cells 12 via the heat spreader 60 due to a differential temperature and heat flux path that moves heat away from the battery cells 12, such as during a cell charging event wherein heat is generated by the electrochemical charging process. Heat transfer can be employed to effect heating or cooling of the battery cells 12 via the heat spreader 60 due to a differential temperature and heat flux path that moves heat towards the battery cells 12, in order to maintain temperature of the battery cells 12 at or near a desired operating temperature.

The stacked arrangement including the plurality of battery cells 12 and interleaved heat spreaders 60 is interposed between the first heat exchanger 20 and the second heat exchanger 40 such that the first end portions 62 of the plurality of heat spreaders 60 are adjacent to and contiguous with an inner portion 36 of the first heat exchanger 20. Likewise, the second, bottom edges 14 of the plurality of battery cells 12 and the second end portions 63 of the plurality of heat spreaders 60 are adjacent to and contiguous with an inner portion 56 of the second heat exchanger 40.

The first and second heat exchangers 20, 40 are coplanar with a plane defined by the longitudinal axis 17 and the transverse axis 18. The first heat exchanger 20 includes a first planar sheet 22 that is assembled onto a second planar sheet 24, wherein both the first and second planar sheets 22, 24 are fabricated from sheet metal such as aluminum. The first planar sheet 22 is preferably disposed towards the stacked arrangement including the plurality of battery cells 12 and interleaved heat spreaders 60, and forms the inner portion 36 of the first heat exchanger 20. The second planar sheet 24 is disposed outwardly in relation thereto. In one embodiment, the first planar sheet 22 is formed to include a plurality of fluidic channels 25 that are disposed to run substantially in parallel with the transverse axis 18 from a first edge 29 to a second edge 30 of the first planar sheet 22. Each of the fluidic channels 25 is formed to have a cross-sectional shape that may be rectangular, trapezoidal, semi-circular, elliptical, or another suitable shape, wherein such forming can be accomplished by a metal stamping process. A plurality of fluidic conduits 26 are formed by the plurality of fluidic channels 25 when the first planar sheet 22 is assembled onto the second planar sheet 24, and each of the fluidic conduits 26 has a first port 27 that is disposed on the first edge 29 and a second port 28 that is disposed on the second edge 30. A first fluidic manifold 32 is disposed on the first edge 29, and is a tube that is preferably formed from aluminum that includes a plurality of first manifold ports 33 that correspond in location to respective ones of the first ports 27 of the plurality of fluidic conduits 26. Each of the first manifold ports 33 are joined to corresponding ones of the first ports 27 of the plurality of fluidic conduits 26 to effect fluidic flow therebetween. Similarly, a second fluidic manifold 34 is disposed on the second edge 30, and is also a tube that is preferably formed from aluminum that includes a plurality of second manifold ports 35 that correspond in location to respective ones of the second ports 28 of the plurality of fluidic conduits 26. Each of the second manifold ports 35 are joined to corresponding ones of the second ports 28 of the plurality of fluidic conduits 26 to effect fluidic flow therebetween. In this manner, the plurality of fluidic conduits 26 are disposed to provide fluidic communication between the first and second fluidic manifolds 32, 34.

The second heat exchanger 40 is arranged in a manner that is similar to the first heat exchanger 20, and includes a first planar sheet 42 that is assembled onto a second planar sheet 44, wherein both the first and second planar sheets 42, 44 are fabricated from sheet metal such as aluminum. The first planar sheet 42 is preferably disposed towards the stacked arrangement including the plurality of battery cells 12 and interleaved heat spreaders 60, and forms the inner portion 56 of the second heat exchanger 40. The second planar sheet 44 is disposed outwardly. In one embodiment, the first planar sheet 42 is formed to include a plurality of fluidic channels 45 that are disposed to run substantially in parallel with the transverse axis 18 from a first edge 49 to a second edge 50 of the first planar sheet 42. Each of the fluidic channels 45 is formed to have a cross-sectional shape that may be rectangular, trapezoidal, semi-circular, elliptical, or another suitable shape, wherein such forming can be accomplished by a metal stamping process. A plurality of fluidic conduits 46 are formed by the plurality of fluidic channels 45 when the first planar sheet 42 is assembled onto the second planar sheet 44, and each of the fluidic conduits 46 has a first port 47 that is disposed on the first edge 49 and a second port 48 that is disposed on the second edge 50. A first fluidic manifold 52 is disposed on the first edge 49, and is a tube that is preferably formed from aluminum that includes a plurality of first manifold ports 53 that correspond in location to respective ones of the first ports 47 of the plurality of fluidic conduits 46. Each of the first manifold ports 53 are joined to corresponding ones of the first ports 47 of the plurality of fluidic conduits 46 to effect fluidic flow therebetween. Similarly, a second fluidic manifold 54 is disposed on the second edge 50, and is also a tube that is preferably formed from aluminum that includes a plurality of second manifold ports 55 that correspond in location to respective ones of the second ports 48 of the plurality of fluidic conduits 46. Each of the second manifold ports 55 are joined to corresponding ones of the second ports 48 of the plurality of fluidic conduits 46 to effect fluidic flow therebetween. In this manner, the plurality of fluidic conduits 46 are disposed to provide fluidic communication between the first and second fluidic manifolds 52, 54.

Each of the first and second planar sheets 22, 24 of the first heat exchanger 20 and the first and second planar sheets 42, 44 of the second heat exchanger 40 can be formed from aluminum. Furthermore, the fluidic conduits 26 and 46 are each preferably set at small inside diameters to minimize volume (and hence mass) of coolant contained therein.

Each of the first end portions 62 of the heat spreaders 60 is in thermal contact with the inner surface 36 of the first heat exchanger 20 and each of the second end portions 63 of the heat spreaders 60 is in thermal contact with the inner surface 56 of the second heat exchanger 40.

A thermally-conductive material 74 is applied between the first end portions 62 of the heat spreaders 60 and the inner surface 36 of the first heat exchanger 20 to effect thermal contact therebetween and, in one embodiment structurally bonds the heat spreaders 60 and the first heat exchanger 20. Preferably, the thermally-conductive material 74 is applied to the complete area defined by the inner surface 36. The thermally-conductive material 74 is also applied between the second end portions 63 of the heat spreaders 60 and the inner surface 56 of the second heat exchanger 40 to effect thermal contact therebetween and to structurally bond the heat spreaders 60 and the second heat exchanger 40. Preferably, the thermally-conductive material 74 is applied to the complete area defined by the inner surface 56.

The stacked arrangement including the plurality of battery cells 12 and interleaved heat spreaders 60 is interposed between the first heat exchanger 20 and the second heat exchanger 40 such that the first, top edges 13 of the plurality of battery cells 12 and the first end portions 62 of the plurality of heat spreaders 60 are adjacent to and contiguous with an inner portion 36 of the first heat exchanger 20. Likewise, the second, bottom edges 14 of the plurality of battery cells 12 and the second end portions 63 of the plurality of heat spreaders 60 are adjacent to and contiguous with an inner portion 56 of the second heat exchanger 40.

The first heat exchanger 20 includes a first manifold port 37 that fluidly couples to the first manifold 32 and a second manifold port 38 that fluidly couples to the second manifold 34, wherein the first and second manifold ports 37, 38 can be fluidly coupled to a heat exchange circuit 39 that preferably includes a fluidic pump, an air/fluid heat exchanger, and a sump, wherein a coolant fluid is circulated therethrough to effect heat transfer. The first and second manifold ports 37, 38 can employ suitable connectors, e.g., quick-connect devices.

Similarly, the second heat exchanger 40 includes a first manifold port 57 that fluidly couples to the first manifold 52 and a second manifold port 58 that fluidly couples to the second manifold 54, wherein the first and second manifold ports 57, 58 can be fluidly coupled to a heat exchange circuit 59 that preferably includes a fluidic pump, an air/fluid heat exchanger, and a sump, wherein a coolant fluid is circulated therethrough to effect heat transfer. In one embodiment, the heat exchange circuit 59 and the heat exchange circuit 39 are composed of the same devices, and the first and second heat exchangers 20, 40 are fluidly coupled in parallel thereto. In one embodiment, a selectively controllable fluidic heater can be employed to control temperature of the coolant that is circulated through the heat exchange circuit 59 and/or the heat exchange circuit 39.

As such, the battery assembly 10 is a high-voltage DC power source having dual cooling plates, i.e., the first and second heat exchangers 20, 40, providing a physically compact design by reducing cooling plate thickness. The use of the thermally-conductive material 74 provides structural and thermal performance, and replaces mechanical fasteners. Compression to a fixed dimension reduces overall length variation. The attachment of the first and second heat exchangers 20, 40 to the stacked arrangement of the battery cells 12 and interleaved heat spreaders 60 provides structural matrix resulting in high strength performance in compact passage. In one embodiment, a total vertical space required for cold plates is less than 5 mm, as compared to greater than 8.5 mm for previous design.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery assembly, comprising:
a plurality of battery cells, a plurality of heat spreaders, a first heat exchanger and a second heat exchanger;
wherein each heat spreader includes a plate portion, a first end portion and a second end portion;
wherein the plurality of battery cells are disposed in a stacked arrangement;
wherein the heat spreaders are interleaved between adjacent ones of the battery cells;
wherein each of the first and second heat exchangers includes a first planar sheet assembled onto a second planar sheet, wherein a plurality of fluidic channels are disposed between the first and second planar sheets, and wherein a first fluidic manifold is disposed on a first edge and a second fluidic manifold is disposed on a second opposed edge of each of the first and second heat exchangers;
wherein each of the fluidic channels includes a first port that is in fluidic communication with the first manifold and a second port that is in fluidic communication with the second manifold;
wherein each of the fluidic channels is disposed to provide fluidic communication between the first and second fluidic manifolds;
wherein the stacked arrangement of the plurality of battery cells and interleaved heat spreaders is interposed between the first heat exchanger and the second heat exchanger; and
wherein each of the first end portions of the heat spreaders is in thermal contact with the first heat exchanger and wherein each of the second end portions of the heat spreaders is in thermal contact with the second heat exchanger.

2. The battery assembly of claim 1, wherein each of the battery cells is configured as a rectangular prism and includes a first/upper edge, a second/lower edge, opposed face portions and electrical terminal ends.

3. The battery assembly of claim 1, wherein the heat spreaders are interleaved between adjacent ones of the battery cells such that the plate portion of each of the heat spreaders is in thermal communication with the adjacent ones of the battery cells.

4. The battery assembly of claim 3, wherein the thermal communication includes conductive heat transfer, radiant heat transfer and convective heat transfer.

5. The battery assembly of claim 3, wherein the heat spreaders are fabricated from one of aluminum, stainless steel, or high-strength steel.

6. The battery assembly of claim 1, wherein the first portions of the heat spreaders are bonded to the first heat exchanger via a thermally-conductive material, wherein the second portions of the heat spreaders are bonded to the second heat exchanger via the thermally-conductive material.

7. The battery assembly of claim 1, wherein the first end portion of the heat spreader is in thermal communication with the first heat exchanger and the second end portion is in thermal communication with the second heat exchanger, and wherein each of the heat spreaders is in thermal contact with the respective inner portion of the first planar sheet and the respective inner portion of the second planar sheet via the thermally-conductive material.

8. The battery assembly of claim 1, wherein the first and second planar sheets of the first and second heat exchangers are fabricated from one of aluminum, stainless steel, or high-strength steel.

9. The battery assembly of claim 1, wherein each of the battery cells comprises a rechargeable lithium-ion battery cell.

10. The battery assembly of claim 1, wherein the first manifold is arranged in parallel with the second fluidic manifold for each of the first and second heat exchange plates.

11. The battery assembly of claim 1, wherein the first fluidic manifold, the plurality of fluidic channels and the second fluidic manifold form a single-pass fluidic flow circuit in each of the first and second heat exchange plates.

12. The battery assembly of claim 1, wherein each of the first and second heat exchangers is arranged in a single-pass fluidic flow circuit that includes the first fluidic manifold, the plurality of fluidic channels and the second fluidic manifold.

13. The battery assembly of claim 1, wherein each of the fluidic channels has a rectangular, trapezoidal, semi-circular or elliptical cross-sectional shape.

14. A battery assembly, comprising:
a plurality of battery cells, a plurality of heat spreaders, a first heat exchanger and a second heat exchanger;
wherein each heat spreader includes a plate portion, a first end portion and a second end portion;
wherein the plurality of battery cells are disposed in a stacked arrangement;
wherein the heat spreaders are interleaved between adjacent ones of the battery cells;
wherein each of the first and second heat exchangers includes a first planar sheet assembled onto a second planar sheet, wherein a plurality of fluidic channels are disposed between the first and second planar sheets, and wherein a first fluidic manifold is disposed on a first edge and a second fluidic manifold is disposed on a second opposed edge of each of the first and second heat exchangers;
wherein each of the fluidic channels includes a first port that is in fluidic communication with the first manifold and a second port that is in fluidic communication with the second manifold;
wherein each of the fluidic channels is disposed to provide fluidic communication between the first and second fluidic manifolds; and
wherein the plurality of battery cells and interleaved heat spreaders are interposed between the first heat exchanger and the second heat exchanger.

15. The battery assembly of claim 14, wherein each of the battery cells is configured as a rectangular prism and includes a first/upper edge, a second/lower edge, opposed face portions and electrical terminal end.

16. The battery assembly of claim 14, wherein the heat spreaders are interleaved between adjacent ones of the battery cells such that the plate portion of each of the heat spreaders is in thermal communication with the adjacent ones of the battery cells.

17. The battery assembly of claim 16, wherein the thermal communication includes conductive heat transfer, radiant heat transfer and convective heat transfer.

18. The battery assembly of claim 14, wherein the first portions of the heat spreaders are bonded to the first heat exchanger via a thermally-conductive material, wherein the second portions of the heat spreaders are bonded to the second heat exchanger via the thermally-conductive material.

19. The battery assembly of claim 14, wherein the first end portion of the heat spreader is in thermal communication with the first heat exchanger and the second end portion is in thermal communication with the second heat exchanger, and wherein each of the heat spreaders is in thermal contact with the respective inner portion of the first planar sheet and the respective inner portion of the second planar sheet via the thermally-conductive material.

20. The battery assembly of claim 14, wherein each of the battery cells comprises a rechargeable lithium-ion battery cell.
